(19) United States
(12) Patent Application Publication
(10) Pub. No.: US 2021/0229687 A1
(43) Pub. Date: Jul. 29, 2021

(54) VEHICLE CONTROLLER, VEHICLE CONTROL SYSTEM, VEHICLE CONTROL METHOD, AND VEHICLE CONTROL SYSTEM CONTROL METHOD

(71) Applicant: TOYOTA JIDOSHA KABUSHIKI KAISHA, Toyota-shi (JP)

(72) Inventors: Yosuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/146,626

(22) Filed: Jan. 12, 2021

(30) Foreign Application Priority Data
Jan. 29, 2020 (JP) 2020-012548

(51) Int. Cl. B60W 50/04; G07C 5/08

(52) U.S. Cl. CPC B60W 50/045; B60W 2050/0083; B60W 2050/046; G07C 5/0808

(57) ABSTRACT

A vehicle controller, a vehicle control system, a vehicle control method, and a vehicle control system control method are provided. An internal execution device of the vehicle controller detects that learning data stored by an internal memory device due to the occurrence of an anomaly in a vehicle. The internal execution device transmits, to the outside of the vehicle, a request signal that requests for previously-learned learning data, where learning is performed from an initial state of the learning data. The internal execution device causes the internal memory device to store the received previously-learned learning data instead of the reset learning data.

### BACKGROUND

### 1. Field

The present disclosure relates to a vehicle controller, a vehicle control system, a vehicle control method, and a vehicle control system control method.

### 2. Description of Related Art

Japanese Laid-Open Patent Publication No. 2010-270686 discloses an ignition timing controller for an internal combustion engine that calculates an ignition timing so as to perform ignition at an advanced side in a range where knocking does not occur. For the ignition timing, a basic ignition timing serving as a base is corrected by a feedback term that is based on an output value of a knocking sensor Further, the ignition timing is corrected by a learning parameter updated using the feedback term.

The learning parameter is updated from its previous learning parameter to correct and calculate the ignition timing of the internal combustion engine using the updated learning parameter. Repeatedly updating the learning parameter causes the calculated ignition timing to approach a suitable ignition timing.

In the ignition timing controller for the internal combustion engine in the above-described document, when an anomaly such as battery-removal memory clearance occurs, the information of the stored previous learning parameter may be lost. In this case, the learning parameter is set to an initial value. However, when the learning parameter is set to the initial value, it takes time for the learning parameter of the ignition timing to become a suitable learning parameter through the repetition of the update from the initial value. This is not limited to the learning parameter of the ignition timing, and the same applies to a learning parameter related to the control of an electronic device installed in a vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the present disclosure will now be described.

Aspect 1: An aspect of the present disclosure provides a vehicle controller. The vehicle controller includes an in-vehicle controller that includes an internal memory device and an internal execution device. The internal memory device is configured to store learning data used to control an electronic device installed in a vehicle. The internal execution device is configured to execute an obtaining process that obtains a detection value of a sensor that detects a state of the vehicle, an update process that updates the learning data through learning with traveling of the vehicle and causes the internal memory device to store the updated learning data, an operation process that operates the electronic device based on the detection value obtained by the obtaining process and based on a value of a variable that is related to an operation of the electronic device in the vehicle and is defined by the learning data, a detecting process that detects that the learning data stored in the internal memory device has been reset due to occurrence of an anomaly in the vehicle, a transmitting process that transmits, to an outside of the vehicle, a request signal that requests for previously-learned learning data, where learning is performed from an initial state of the learning data, when the detecting process detects that the learning data has been reset, a receiving process that receives, from the outside of the vehicle, the previously-learned learning data corresponding to the request signal, and a switching process that causes the internal memory device to store the previously-learned learning data received by the receiving process instead of the reset learning data.

In the above-described configuration, when it is detected that the learning data has been reset due to the occurrence of an anomaly in the vehicle, the reset learning data is switched by the previously-learned learning data. Thus, the learning of learning data is resumed from the previously-learned learning data, which is closer to a suitable state than learning data in the initial state. This shortens the time for the update process to set the learning data to a suitable state.

Aspect 2: Another aspect of the present disclosure provides a vehicle control system. The vehicle control system includes an in-vehicle controller installed in a vehicle and an out-of-vehicle controller arranged outside of the vehicle. The in-vehicle controller includes an internal memory device and an internal execution device. The out-of-vehicle controller includes an external memory device and an external execution device. The internal memory device is configured to store learning data used to control an electronic device installed in the vehicle. The external memory device is configured to store previously-learned learning data, where learning is performed from an initial state of the learning data. The internal execution device is configured to execute an obtaining process that obtains a detection value of a sensor that detects a state of the vehicle, an update process that updates the learning data through learning with traveling of the vehicle and causes the internal memory device to store the updated learning data, an operation process that operates the electronic device based on the detection value obtained by the obtaining process and based on a value of a variable that is related to an operation of the electronic device in the vehicle and is defined by the learning data, a detecting process that detects that the learning data stored in the internal memory device has been reset due to occurrence of an anomaly in the vehicle, and a first transmitting process that transmits, to the out-of-vehicle controller, a request signal that requests for the previously-learned learning data when the detecting process detects that the learning data has been reset. The external execution device is configured to execute a first receiving process that receives, from the internal execution device, the request signal transmitted by the first transmitting process and a second transmitting process that transmits, to the in-vehicle controller, in response to the request signal received by the first receiving process, a signal indicating the previously-learned learning data stored in the external memory device. The internal execution device is configured to execute a second receiving process that receives the signal that indicates the previously-learned learning data, the signal having been transmitted by the second transmitting process, and a switching process that causes the internal memory device to store the previously-learned learning data received by the second receiving process instead of the reset learning data.

In the above-described configuration, even if the learning data stored in the internal memory device has been reset due to the occurrence of an anomaly in the vehicle, the previously-learned learning data is stored in the external memory device. This allows the in-vehicle controller to obtain the previously-learned learning data. Thus, the learning of learning data is resumed from the previously-learned learning data, which is closer to a suitable state than learning data in the initial state. This shortens the time for the update process to set the learning data to a suitable state.

Aspect 3: In the vehicle control system, the internal execution device may be configured to execute a periodical transmitting process that transmits, to the out-of-vehicle controller for a predetermined period, a signal indicating the learning data updated by the update process. The external execution device may be configured to execute a periodical receiving process that receives the signal that indicates the learning data, the signal having been transmitted by the periodical transmitting process and a saving process that saves, as the previously-learned learning data in the external memory device, the learning data received by the periodical receiving process. The previously-learned learning data transmitted by the external execution device in the second transmitting process may be latest data saved by the saving process.

In the above-described configuration, when the in-vehicle controller transmits the learning data updated for the predetermined period, the learning data updated for the predetermined period is saved in the external memory device. When the previously-learned learning data is switched by the switching process, the latest data of the saved learning data is obtained as the previously-learned learning data.

Aspect 4: In the vehicle control system, the internal execution device may be configured to execute a travel history transmitting process that transmits, to the out-of-vehicle controller, a signal indicating a travel history of the vehicle including the internal execution device. The external execution device may be configured to execute a travel history receiving process that receives signals indicating travel histories, the signals having been transmitted by vehicles, and a travel history saving process that saves, in the external memory device for each of the vehicles, the travel histories received by the travel history receiving process. The previously-learned learning data transmitted by the second transmitting process may be associated with a travel history closest to the travel history of the vehicle that transmitted the request signal, of the travel histories of the vehicles saved by the travel history saving process.

In the above-described configuration, each of the travel histories of the vehicles and the corresponding previously-learned learning data are associated with each other. As long as the previously-learned learning data is associated with a travel history close to the travel history obtained when the learning data is reset, the vehicle that transmitted the request signal receives not only the previously-learned learning data transmitted by the vehicle that transmits the request signal but also the previously-learned learning data transmitted by a different vehicle. Accordingly, the vehicle that transmits the request signal is highly likely to obtain a more suitable previously-learned learning data that corresponds to the travel history obtained when the learning data is reset.

Aspect 5: In the vehicle control system, traveling histories and multiple of the previously-learned learning data respectively corresponding to the travel histories may be set in advance for the external memory device in association with each other. The internal execution device may be configured to transmit, in the first transmitting process, a signal indicating a travel history of the vehicle when the learning data of the vehicle is reset. The external execution device may be configured to receive the travel history in the first receiving process. The previously-learned learning data transmitted by the external execution device in the second transmitting process may be associated with a travel history closest to the travel history of the vehicle that transmitted the request signal, of the travel histories stored in the external memory device.

The above-described configuration allows the vehicle that transmitted the request signal to receive the previously-learned learning data closest to the travel history obtained when the learning data is reset, of the previously-learned learning data that has been set in advance. Accordingly, even without the internal execution device transmitting the previously-learned learning data, the vehicle that transmits the request signal is highly likely to obtain a more suitable previously-learned learning data that corresponds to the travel history obtained when the learning data is reset.

Aspect 6: In the vehicle control system, the learning data may be relationship defining data that defines a relationship between the state of the vehicle and an action variable related to the operation of the electronic device in the vehicle, the internal execution device may be configured to execute a reward calculating process that provides, based on the detection value obtained by the obtaining process, a greater reward when a characteristic of the vehicle meets a standard than when the characteristic of the vehicle does not meet the standard. The update process may update the relationship defining data by inputting, to a predetermined update map, the state of the vehicle that is based on the detection value obtained by the obtaining process, the value of the action variable used to operate the electronic device, and the reward corresponding to the operation of the electronic device. The update map may output the updated relationship defining data so as to increase an expected return for the reward in a case where the electronic device is operated in accordance with the relationship defining data.

In the above-described configuration, since the learning data is set as the learning data, a relatively large amount of information can be treated. Further, by calculating the reward that results from the operation of the electronic device, it is possible to understand what kind of reward is obtained by the operation. In addition, the reward is used to update the relationship defining data with the update map according to reinforcement learning. This allows the relationship between the state of the variable and the action variable to be appropriate in the traveling of the vehicle.

Aspect 7: A vehicle control method is provided that includes the processes according to Aspect 1.

Aspect 8: A vehicle control system control method is provided that includes the processes according to any one of Aspects 2 to 6.

A non-transitory computer readable memory medium is provided that stores a control process that causes the internal execution device and the internal memory device to execute the processes according to Aspect 1.

A non-transitory computer readable memory medium is provided that stores a control process that causes the in-vehicle controller and the out-of-vehicle controller to execute the processes according to any one of Aspects 2 to 6.

Other features and aspects will be apparent from the following detailed description, the drawings, and the claims.

### BRIEF DESCRIPTION OF THE DRAWINGS

FIG. 1 is a diagram showing a controller and its drive system according to a first embodiment of the present disclosure.

FIG. 2 is a diagram showing the vehicle control system according to the first embodiment.

FIG. 3 is a flowchart showing a procedure of processes executed by the controller according to the first embodiment.

FIG. 4 is a flowchart showing a detailed procedure of some of the processes executed by the controller according to the first embodiment.

FIG. 5 includes sections (a) and (b), which show a procedure of processes executed by the vehicle control system according to the first embodiment.

FIG. 6 includes sections (a) and (b), which show a procedure of processes executed by the vehicle control system according to a second embodiment.

FIG. 7 is a diagram showing the vehicle control system according to a third embodiment of the present disclosure.

FIG. 8 includes sections (a) and (b), which show a procedure of processes executed by the vehicle control system according to the third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

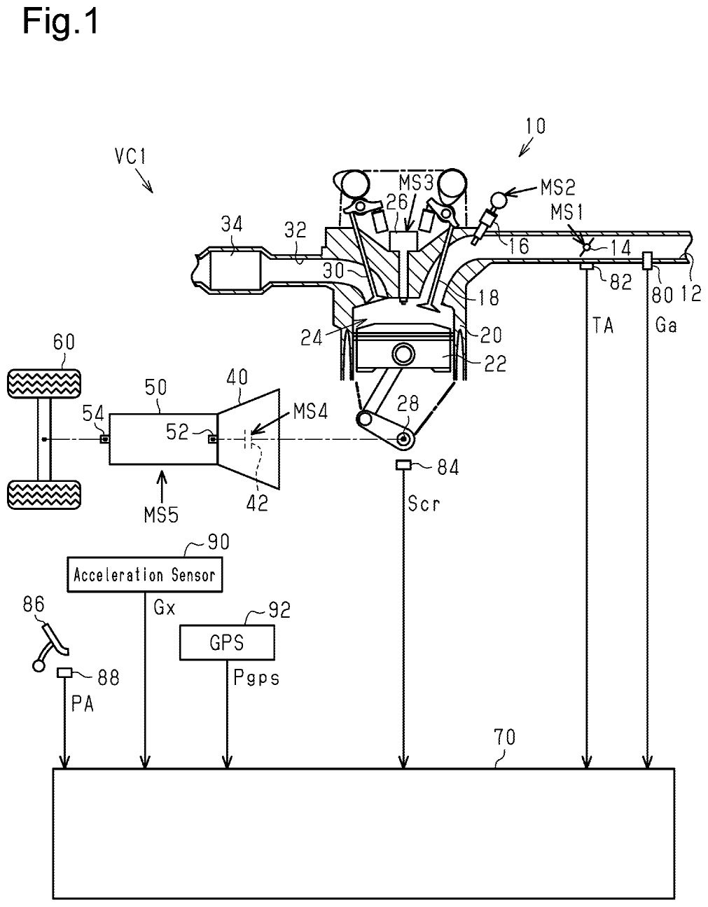

A vehicle controller according to a first embodiment will now be described with reference to FIGS. 1 to 5.

FIG. 1 shows the configuration of a drive system of a vehicle VC1 and a controller 70 according to the present embodiment.

As shown in FIG. 1, an internal combustion engine 10 includes an intake passage 12, in which a throttle valve 14 and a fuel injection valve 16 are arranged in that order from the upstream side. Air drawn into the intake passage 12 and fuel injected from the fuel injection valve 16 flow into a combustion chamber 24, which is defined by a cylinder 20 and a piston 22, when an intake valve 18 is opened. In the combustion chamber 24, air-fuel mixture is burned by spark discharge of an ignition device 26. The energy generated by the combustion is converted into rotational energy of a crankshaft 28 via the piston 22. The burned air-fuel mixture is discharged to an exhaust passage 32 as exhaust gas when an exhaust valve 30 is opened. The exhaust passage 32 incorporates a catalyst 34, which is an aftertreatment device for purifying exhaust gas.

The crankshaft 28 is mechanically couplable to an input shaft 52 of a transmission 50 via a torque converter 40 equipped with a lockup clutch 42. The transmission 50 variably sets the gear ratio, which is the ratio of the rotation speed of the input shaft 52 and the rotation speed of an output shaft 54. The output shaft 54 is mechanically coupled to driven wheels 60.

The controller 70 controls the internal combustion engine 10 and operates operated units of the engine 10 such as the throttle valve 14, the fuel injection valve 16, and the ignition device 26, thereby controlling the torque and the ratios of exhaust components, which are controlled variables of the internal combustion engine 10. The controller 70 also controls the torque converter 40 and operates the lockup clutch 42 to control the engagement state of the lockup clutch 42. Further, the controller 70 controls and operates the transmission 50, thereby controlling the gear ratio, which is the controlled variable of the transmission 50. FIG. 1 shows operation signals MS1 to MS5 respectively corresponding to the throttle valve 14, the fuel injection valve 16, the ignition device 26, the lockup clutch 42, and the transmission 50.

To control the controlled variables, the controller 70 refers to an intake air amount Ga detected by an air flow meter 80, an opening degree of the throttle valve 14 detected by a throttle sensor 82 (throttle opening degree TA), and an output signal Scr of a crank angle sensor 84. The controller 70 also refers to a depression amount of an accelerator pedal 86 (accelerator operation amount PA) detected by an accelerator sensor 88 and an acceleration Gx in the front-rear direction of the vehicle VC1 detected by an acceleration sensor 90. The controller 70 further refers to position data Pgps, which is obtained by a global positioning system (GPS 92).

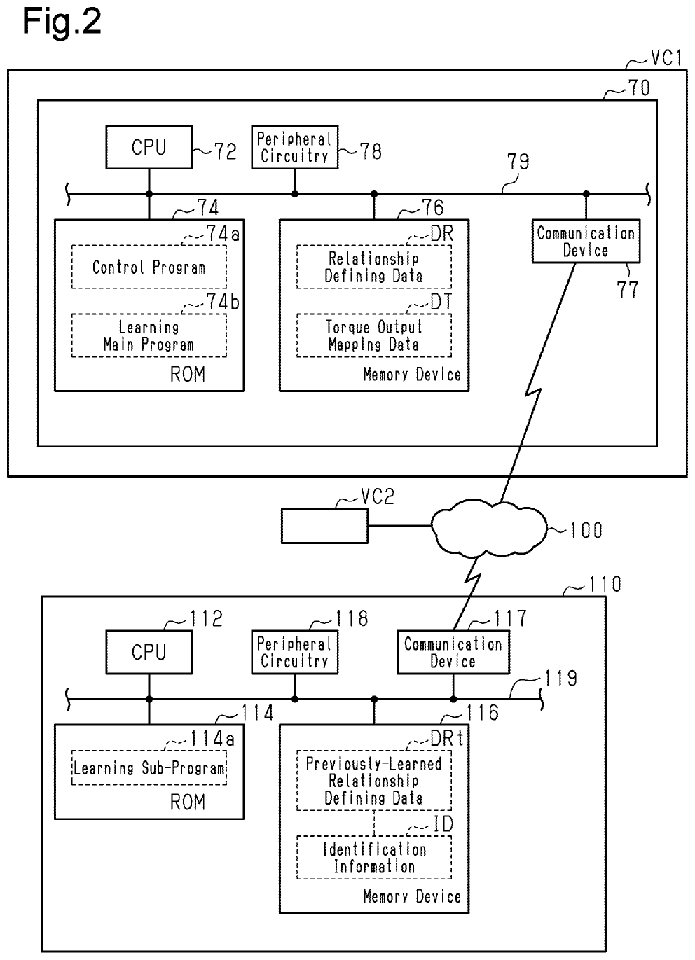

FIG. 2 shows the configuration of the vehicle control system that controls the vehicle VC1.

As shown in FIG. 2, the controller 70 in the vehicle VC1 includes a CPU 72, a ROM 74, a nonvolatile memory that can be electrically rewritten (memory device 76), and peripheral circuitry 78, which can communicate with one another through a local network 79. The peripheral circuitry 78 includes a circuit that generates a clock signal regulating internal operations, a power supply circuit, and a reset circuit.

The ROM 74 stores a control program 74a and a learning main program 74b. The memory device 76 stores relationship defining data DR. The relationship defining data DR defines the relationship of the accelerator operation amount PA with a command value of the throttle opening degree TA (throttle command value TA*) and a retardation amount aop of the ignition device 26. The retardation amount aop is a retardation amount in relation to a predetermined reference ignition timing. The reference ignition timing is the more retarded one of a MBT ignition timing and a knock limit point. The MBT ignition timing is the ignition timing at which the maximum torque is obtained (maximum torque ignition timing). The knock limit point is the advancement limit value of the ignition timing at which knocking can be limited to an allowable level under the assumed best conditions when a large-octane-number fuel, which has a large knock limit value, is used. The memory device 76 also stores torque output mapping data DT. The torque output mapping data DT defines a torque output map. A rotation speed NE of the crankshaft 28, a charging efficiency η, and the ignition timing are input to the torque output map, which in turn outputs a torque Trq.

The controller 70 includes a communication device 77. The communication device 77 communicates with a data analysis center 110 via a network 100, which is arranged outside of the vehicle VC1.

The data analysis center 110 analyzes the data transmitted from the vehicle VC1. The data analysis center 110 receives the data transmitted from other vehicles VC2, . . . . Although not illustrated in the FIG. 2, the vehicle VC2 also includes the controller 70 in the same manner as the vehicle VC1.

The data analysis center 110 includes a CPU 112, a ROM 114, a nonvolatile memory device 116 that can be electrically rewritten, peripheral circuitry 118, and a communication device 117. These components can communicate with each other through a local network 119. The ROM 114 stores a learning sub-program 114a. The memory device 116 stores identification information ID, which is used to identify a vehicle, and previously-learned relationship defining data DRt (described later) such that they are associated with each other. In this manner, the vehicle control system of the present embodiment includes the controller 70, which is installed in the vehicles VC1, VC2, and the data analysis center 110, which is arranged outside of the vehicle VC1.

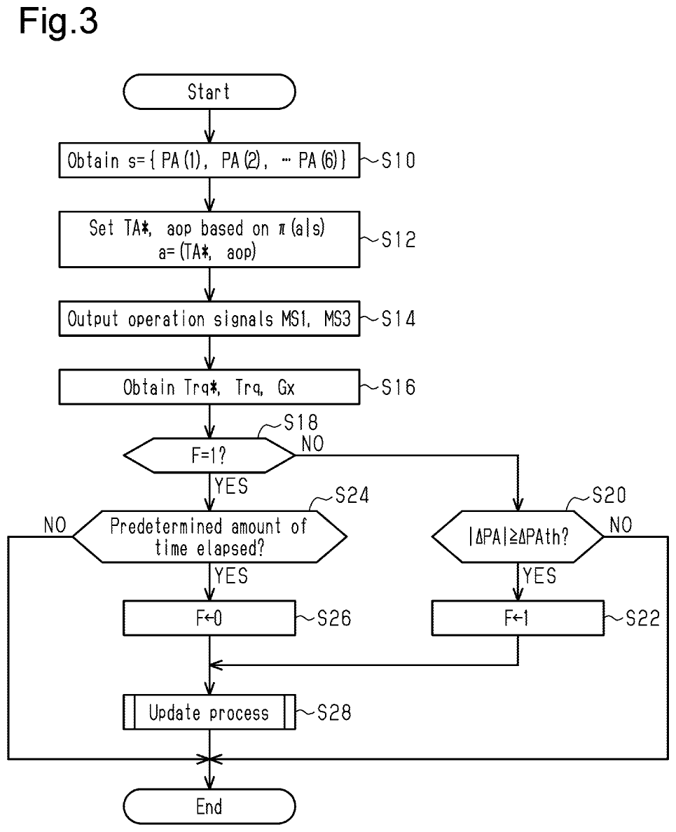

FIG. 3 shows a procedure of processes executed by the controller 70 of the present embodiment. The processes shown in FIG. 3 are implemented by the CPU 72 repeatedly executing the control program 74a and the learning main program 74b stored in the ROM 74, for example, at predetermined intervals. In the following description, the number of each step is represented by the letter S followed by a numeral.

In the series of processes shown in FIG. 3, the CPU 72 first acquires, as a state s, time-series data including six sampled values PA(1), PA(2), . . . PA(6) (S10). The sampled values included in the time-series data have been sampled at different points in time. In the present embodiment, the time-series data includes six sampled values that are consecutive in time in a case in which the values are sampled at a constant sample period.

Next, in accordance with a policy it defined by the relationship defining data DR, the CPU 72 sets an action a that corresponds to the state s obtained through the process of S10 and includes the throttle command value TA* and retardation amount aop (S12).

In the present embodiment, the relationship defining data DR is used to define an action value function Q and the policy it. In the present embodiment, the action value function Q is a table-type function representing values of expected return in accordance with eight-dimensional independent variables including the state s and the action a. When a state s is provided, the action value function Q includes values of the action a at which the independent variable is the provided state s. Among these values, the one at which the expected return is maximized is referred to as a greedy action. The policy it defines rules with which the greedy action is preferentially selected, and an action a different from the greedy action is selected with a predetermined probability.

Specifically, the number of the values of the independent variable of the action value function Q according to the present embodiment is obtained by deleting a certain amount from all the possible combinations of the state s and the action a, referring to human knowledge and the like. For example, in time-series data of the accelerator operation amount PA, human operation of the accelerator pedal 86 would never create a situation in which one of two consecutive values is the minimum value of the accelerator operation amount PA and the other is the maximum value. Accordingly, the action value function Q is not defined for this combination of the values. In the present embodiment, reduction of the dimensions based on human knowledge limits the number of the possible values of the state s defined by the action value function Q to a number less than or equal to 10 to the fourth power, and preferably, to a number less than or equal to 10 to the third power.

Next, the CPU 72 outputs the operation signal MS1 to the throttle valve 14 based on the set throttle command value TA* and retardation amount aop, thereby controlling the throttle opening degree TA, and outputs the operation signal MS3 to the ignition device 26, thereby controlling the ignition timing (S14). The present embodiment illustrates an example in which the throttle opening degree TA is feedback-controlled to the throttle command value TA*. Thus, even if the throttle command value TA* remains the same value, the operation signal MS1 may have different values. For example, when a known knock control system (KCS) is operating, the value obtained by retarding the reference ignition timing by the retardation amount aop is used as the value of the ignition timing corrected through feedback correction in the KCS. The reference ignition timing is varied by the CPU 72 in correspondence with the rotation speed NE of the crankshaft 28 and the charging efficiency n. The rotation speed NE is calculated by the CPU 72 based on the output signal Scr of the crank angle sensor 84. The charging efficiency η is calculated by the CPU 72 based on the rotation speed NE and the intake air amount Ga.

Subsequently, the CPU 72 obtains the torque command value Trq* for the internal combustion engine 10, the acceleration Gx, and a torque Trq of the internal combustion engine 10 (S16). The CPU 112 calculates the torque Trq by inputting the rotation speed NE and the charging efficiency η to the torque output map. Further, the CPU 72 sets the torque command value Trq* in accordance with the accelerator operation amount PA.

Next, the CPU 72 determines whether a transient flag F is 1 (S18). The value 1 of the transient flag F indicates that a transient operation is being performed, and the value 0 of the transient flag F indicates that the transient operation is not being performed. When determining that the transient flag F is 0 (S18: NO), the CPU 72 determines whether the absolute value of a change amount per unit time ΔPA of the accelerator operation amount PA is greater than or equal to a predetermined amount ΔPAth (S20). The change amount per unit time ΔPA simply needs to be the difference between the latest accelerator operation amount PA at the point in time of execution of S20 and the accelerator operation amount PA of the point in time that precedes the execution of S40 by a certain amount of time.

When determining that the absolute value of the change amount per unit time ΔPA is greater than or equal to the predetermined amount ΔPAth (S20: YES), the CPU 72 assigns 1 to the transient flag F (S22).

In contrast, when determining that the transient flag F is 1 (S18: YES), the CPU 72 determines a predetermined amount of time has elapsed from the point in time of execution of the process of S22 (S24). The predetermined amount of time is an amount of time during which the absolute value of the change amount per unit time ΔPA of the accelerator operation amount PA remains less than or equal to a specified amount that is less than the predetermined amount ΔPAth. When determining that the predetermined amount of time has elapsed from the point in time of execution of S22 (S24: YES), the CPU 72 assigns 0 to the transient flag F (S26).

When the process of S22 or S26 is completed, the CPU 72 assumes that one episode has ended and performs reinforcement learning to update the action value function Q (S28).

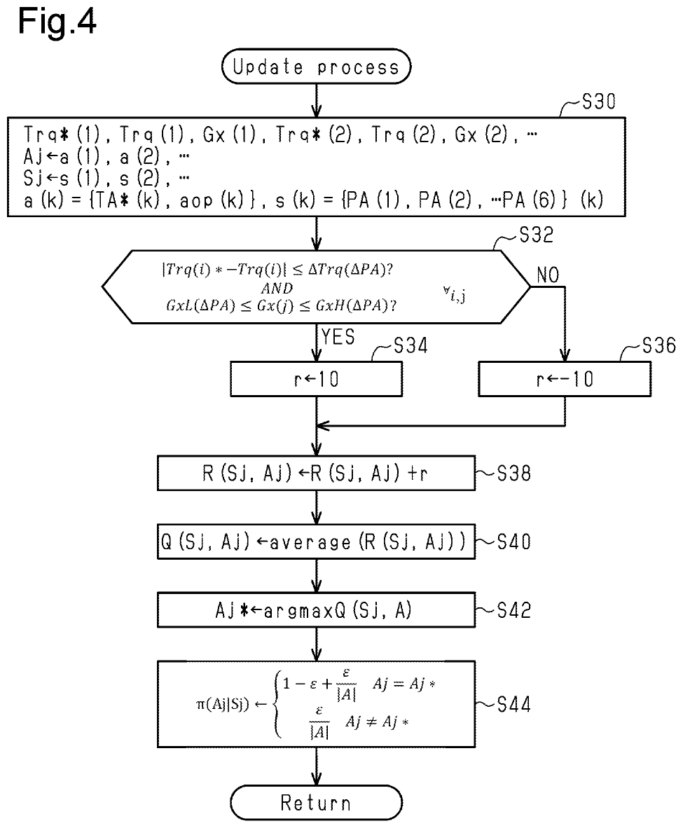

FIG. 4 illustrates the details of the process of S28.

In a series of processes shown in FIG. 4, the CPU 72 acquires time-series data including groups of three sampled values of the torque command value Trq*, the torque Trq, and the acceleration Gx in the episode that has been ended most recently, and time-series data of the state s and the action a (S30). The most recent episode has a time period during which the transient flag F was continuously 0 if the process of S30 of FIG. 4 is executed after the process of S22 of FIG. 3. The most recent episode has a time period during which the transient flag F was continuously 1 if the process of S30 of FIG. 4 is executed after the process of S26 of FIG. 3.

In FIG. 4, variables of which the numbers in parentheses are different are variables at different sampling points in time. For example, a torque command value Trq*(1) and a torque command value Trq*(2) have been obtained at different sampling points in time. The time-series data of the action a belonging to the most recent episode is defined as an action set Aj, and the time-series data of the state s belonging to the same episode is defined as a state set Sj.

Next, the CPU 72 determines whether the logical conjunction of the following conditions (i) and (ii) is true (S32). The condition (i) is that the absolute value of the difference between an arbitrary torque Trq belonging to the most recent episode and the torque command value Trq* is less than or equal to a specified amount ΔTrq. The condition (ii) is that the acceleration Gx is greater than or equal to a lower limit GxL and less than or equal to an upper limit GxH.

The CPU 72 varies the specified amount ΔTrq depending on the change amount per unit time ΔPA of the accelerator operation amount PA at the start of the episode. That is, the CPU 72 determines that the episode is related to transient time if the absolute value of the change amount per unit time ΔPA is great and sets the specified amount ΔTrq to a greater value than in a case in which the episode related to steady time.

The CPU 72 varies the lower limit GxL depending on the change amount per unit time ΔPA of the accelerator operation amount PA at the start of the episode. That is, when the episode is related to transient time and the change amount per unit time ΔPA has a positive value, the CPU 72 sets the lower limit GxL to a greater value than in a case in which the episode is related to steady time. When the episode is related to transient time and the change amount per unit time ΔPA has a negative value, the CPU 72 sets the lower limit GxL to a smaller value than in a case in which the episode is related to steady time.

Also, the CPU 72 varies the upper limit GxH depending on the change amount per unit time ΔPA per unit time of the accelerator operation amount PA at the start of the episode. That is, when the episode is related to transient time and the change amount per unit time ΔPA has a positive value, the CPU 72 sets the lower limit GxL to a greater value than in a case in which the episode is related to steady time. When the episode is related to transient time and the change amount per unit time ΔPA has a negative value, the CPU 72 sets the lower upper limit GxH to a smaller value than in a case in which the episode is related to steady time.

When determining that the logical conjunction of the condition (i) and the condition (ii) is true (S32: YES), the CPU 72 assigns 10 to a reward r (S34). When determining that the logical conjunction is false (S32: NO), the CPU 72 assigns −10 to the reward r (S36). When the process of S34 or S36 is completed, the CPU 72 updates the relationship defining data DR stored in the memory device 76 shown in FIG. 2. In the present embodiment, the relationship defining data DR is updated by the ε-soft on-policy Monte Carlo method.

That is, the CPU 72 adds the reward r to respective returns R(Sj, Aj), which are determined by pairs of the states obtained through the process of S30 and actions corresponding to the respective states (S38). R(Sj, Aj) collectively represents the returns R each having one of the elements of the state set Sj as the state and one of the elements of the action set Aj as the action. Next, the CPU 112 averages each of the returns R(Sj, Aj), which are determined by pairs of the states and the corresponding actions obtained through the process of S30, and assigns the averaged values to the corresponding action value functions Q(Sj, Aj) (S40). The averaging process simply needs to be a process of dividing the return R, which is calculated through the process of S38, by a number obtained by adding a predetermined number to the number of times the process S38 has been executed. The initial value of the return R simply needs to be set to the initial value of the corresponding action value function Q.

Next, for each of the states obtained through the process of S30, the CPU 72 assigns, to an action Aj*, an action that is the combination of the throttle command value TA* and the retardation amount aop when the corresponding action value function Q(Sj, A) has the maximum value (S42). The sign A represents an arbitrary action that can be taken. The action Aj* can have different values depending on the type of the state obtained through the process of S30. In view of simplification, the action Aj* has the same sign regardless of the type of the state in the present description.

Next, the CPU 72 updates the policy π corresponding to each of the states obtained through the process of S30 (S44). That is, the CPU 112 sets the selection probability of the action Aj* selected through S42 to (1−ε)+ε/|A|, where |A| represents the total number of actions. The number of the actions other than the action Aj* is represented by |A|−1. The CPU 72 sets the selection probability of each of the actions other than the action Aj* to ε/|A|. The process of S44 is based on the action value function Q, which has been updated through the process of S40. Accordingly, the relationship defining data DR, which defines the relationship between the state s and the action a, is updated to increase the return R.

When the process of step S44 is completed, the CPU 72 temporarily suspends the series of processes shown in FIG. 4.

Referring back to FIG. 3, the CPU 72 temporarily suspends the series of processes shown in FIG. 3 when the process of S28 is completed or when a negative determination is made in any of the processes of S20 and S24. The processes from S10 to S26 are implemented by the CPU 72 executing the control program 74a, and the process of S32 is implemented by the CPU 72 executing the learning main program 74b.

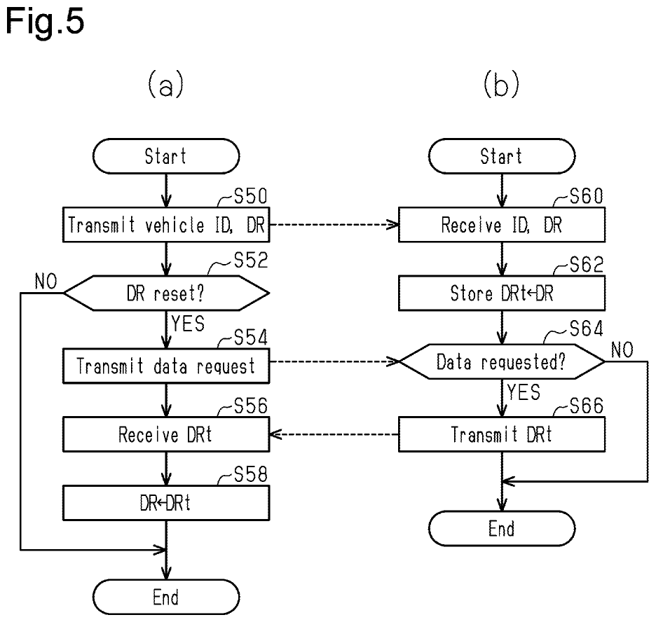

FIG. 5 shows a procedure for dealing with the resetting of the relationship defining data DR in the present embodiment. The processes shown in a section (a) of FIG. 5 are implemented by the CPU 72 repeatedly executing the learning main program 74b stored in the ROM 74 of FIG. 2, for example, at predetermined intervals. The process shown in a section (b) of FIG. 5 is implemented by the CPU 112 executing the learning sub-program 114a stored in the ROM 114. The process shown in FIG. 5 will now be described with reference to the temporal sequence.

In the series of processes shown in the section (a) of FIG. 5, the CPU 72 first operates the communication device 77 to transmit the identification information ID of the vehicle VC1 and the relationship defining data DR (S50).

As shown in the section (b) of FIG. 5, the CPU 112 receives the identification information ID of the vehicle VC1 and the relationship defining data DR (S60). Then, the CPU 112 uses the value of the relationship defining data DR received by the process of S60 to update the previously-learned relationship defining data DRt associated with the identification information ID stored in the memory device 116 (S62).

As shown in the section (a) of FIG. 5, when battery-removal memory clearance is performed, the CPU 72 determines whether the relationship defining data DR stored in the memory device 76 is lost (S52). The battery-removal memory clearance means that, for example, removing a battery serving as the power supply voltage for the controller 70 from the controller 70 causes a back-up voltage for the memory device 76 storing the relationship defining data DR to be lost, so that the information of the relationship defining data DR stored in the memory device 76 is lost. In the present embodiment, when the process of S12 is executable, the relationship defining data DR is determined as not being lost. When the process of S12 is unexecutable due to the battery-removal memory clearance, the relationship defining data DR is determined as being lost.

When determining that the relationship defining data DR is lost (S52: YES), the CPU 72 operates the communication device 77 to transmit a request signal to request a suitable previously-learned relationship defining data DRt as the relationship defining data DR used for the process of S12 (S54).

As shown in the section (b) of FIG. 5, the CPU 112 determines whether the previously-learned relationship defining data DRt has been requested (S64). When determining that the previously-learned relationship defining data DRt has been requested (S64: YES), the CPU 112 operates the communication device 117 to transmit the previously-learned relationship defining data DRt to the vehicle VC1, which issued the request (S66). When completing the process of S66 or making a negative determination in the process of S64, the CPU 112 temporarily suspends the series of processes shown in the section (b) of FIG. 5.

As shown in the section (a) of FIG. 5, the CPU 72 receives the transmitted previously-learned relationship defining data DRt (S56). Then, the CPU 72 uses the previously-learned relationship defining data DRt to switch the relationship defining data DR used for the process of S12 (S58).

When completing the process of S58 or when making a negative determination in the process of S52, the CPU 72 temporarily suspends the series of processes shown in the section (a) of FIG. 5.

The operation and advantages of the first embodiment will now be described.

(1) The CPU 72 obtains the time-series data of the accelerator operation amount PA as the user operates the accelerator pedal 86, and sets the action a, which includes the throttle command value TA* and the retardation amount aop, according to the policy π. Basically, the CPU 72 selects the action a that maximizes the expected return, based on the action value function Q defined by the relationship defining data DR. However, the CPU 72 searches for the action a that maximizes the expected return by selecting, with the predetermined probability ε, actions other than the action a that maximizes the expected return. This allows the relationship defining data DR to be updated to optimal data through reinforcement learning with the traveling of the vehicle VC1 by the user.

In this manner, the relationship defining data DR that was set as initial data by taking a sufficient safety factor into account at the shipment of the vehicle VC1 is updated with the traveling of the vehicle VC1. Thus, if the relationship defining data DR is reset due to the occurrence of an anomaly such as battery-removal memory clearance, setting the relationship defining data DR to initial data and then performing relearning need sufficient time to update the relationship defining data DR to an optimal state.

In the first embodiment, when detecting that the relationship defining data DR has been reset, the CPU 72 receives the previously-learned relationship defining data DRt from outside of the vehicle VC1. Then, the CPU 72 uses the previously-learned relationship defining data DRt to switch the relationship defining data DR. This shortens the time to set the relationship defining data DR to be suitable when the relationship defining data DR is reset as compared with a case where learning is hypothetically resumed from initial data where learning has not been performed.

(2) In the first embodiment, the relationship defining data DR updated with the traveling of the vehicle VC1 is repeatedly transmitted at the predetermined intervals to the data analysis center 110 via the network 100, which is arranged outside of the vehicle VC1. The latest relationship defining data DR is stored by the data analysis center 110 as the previously-learned relationship defining data DRt. When data is requested from the vehicle VC1, the data analysis center 110 transmits, to the controller 70 of the vehicle VC1, the latest relationship defining data DR stored as the previously-learned relationship defining data DRt. Thus, the previously-learned relationship defining data DRt switched when the relationship defining data DR is reset in the vehicle VC1 is the latest previously-learned relationship defining data DRt that has been updated. Accordingly, even if the relationship defining data DR is reset, the action a is searched for based on the latest relationship defining data DR on which the learning prior to the resetting is reflected.

(3) In the first embodiment, the relationship defining data DR is updated through reinforcement learning. Thus, the information related to the operation of many operated units in the vehicle VC1 is treated realistically. Further, what kind of reward r is obtained by operating the operated units is acknowledged realistically. Updating the relationship defining data DR in accordance with reinforcement learning allows the relationship of the state s of the vehicle VC1 with the throttle command value TA* and the retardation amount aop to be suitable in the traveling of the vehicle VC1.

### Second Embodiment

A second embodiment will now be described with reference to the drawings. The differences from the first embodiment will mainly be discussed.

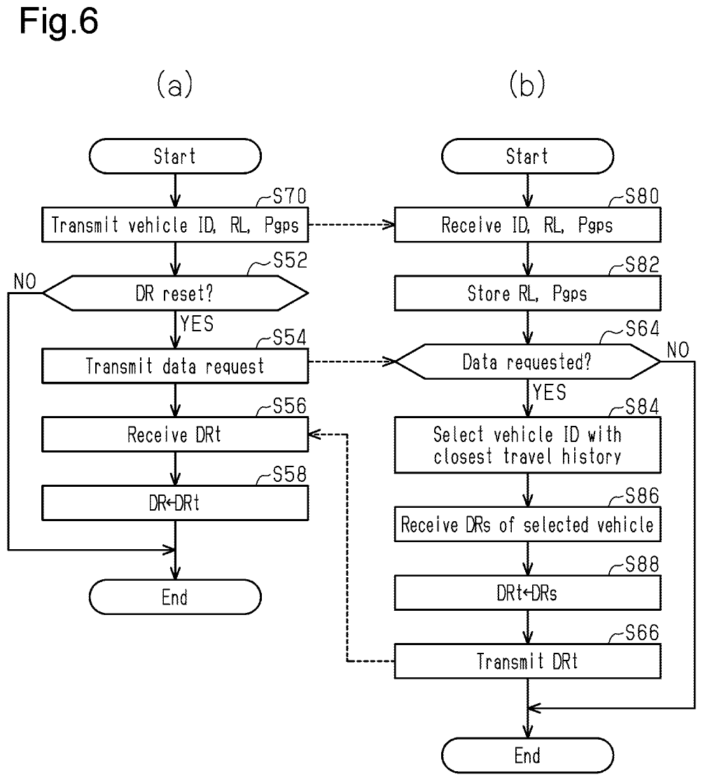

FIG. 6 shows a procedure for dealing with the resetting of the relationship defining data DR in the present embodiment. The processes shown in a section (a) of FIG. 6 are implemented by the CPU 72 repeatedly executing the learning main program 74b stored in the ROM 74 of FIG. 2, for example, at predetermined intervals. The process shown in a section (b) of FIG. 6 is implemented by the CPU 112 executing the learning sub-program 114a stored in the ROM 114. In FIG. 6, the same step numbers are given to the processes that correspond to those in FIG. 5. The process shown in FIG. 6 will now be described with reference to the temporal sequence.

In the series of processes shown in the section (a) of FIG. 6, the CPU 72 first operates the communication device 77 to transmit the identification information ID of the vehicle VC1, a traveled distance RL, and the position data Pgps obtained by the GPS 92 (S70). In the present embodiment, the traveled distance RL refers to the total amount of the distance by which the vehicle has traveled from the production of the vehicle to the current time.

As shown in the section (b) of FIG. 6, the CPU 112 receives the identification information ID, the traveled distance RL, and the position data Pgps (S80). Then, the CPU 112 uses the value received through the process of S80 to update the traveled distance RL and position data Pgps that are associated with the identification information ID stored in the memory device 116 (S82).

As shown in the section (a) of FIG. 6, when the CPU 72 executes the process of S52 and makes an affirmative determination, the CPU 72 executes the process of S54 to transmit a request signal requesting for the previously-learned relationship defining data DRt that is suitable as the relationship defining data DR used for the process of S12 (S54).

As shown in the section (b) of FIG. 6, the CPU 112 executes the process of S64. When determining that the previously-learned relationship defining data DRt has been requested (S64: YES), the CPU 112 selects the vehicle with a travel history that is close to the travel history of the vehicle VC1 that transmitted the request signal (S84). Specifically, the CPU 112 searches for the vehicle with a traveled distance that is within a range of a specific amount in which the traveled distance RL received through S82 is defined as a median in advance. When multiple vehicles have the traveled distance RL that is close to the travel history of the vehicle VC1 that transmitted the request signal, the CPU 112 selects the vehicle with the position data Pgps that is closest to the position data of the vehicle VC1. That is, in the present embodiment, the vehicle with a travel history close to the travel history of the vehicle VC1 that transmitted the request signal is a vehicle with the traveled distance RL that is almost the same as the travel history of the vehicle VC1 and a vehicle with the position data Pgps close to the position data of the vehicle VC1.

The vehicle with the position data Pgps close to the position data of the vehicle VC1 is selected from multiple vehicles with a traveled distance close to the traveled distance of the vehicle VC1 for the following reasons. That is, the relationship defining data DR in a vehicle located relatively close to the vehicle VC1 accordingly has a small environmental difference from the relationship defining data DR of the vehicle VC1. In other words, the relationship defining data DR in a vehicle located relatively close to the vehicle VC1 tends to be suitable for increasing the expected return for the vehicle VC1. Further, a vehicle with the traveled distance RL that is within the range of the specific amount is set as a candidate vehicle with the traveled distance close to the traveled distance of the vehicle VC1 in order to identify a vehicle indicating component deterioration similar to the component deterioration of the vehicle VC1.

Next, the CPU 112 operates the communication device 117 to prompt the vehicle selected in S84 to transmit the relationship defining data DR and receive, as selected relationship defining data DRs, the relationship defining data DR transmitted from the selected vehicle (S86). Then, the CPU 112 assigns the selected relationship defining data DRs to the previously-learned relationship defining data DRt (S88). Subsequently, the CPU 112 executes the process of S66. When completing the process of S66 or making a negative determination in the process of S64, the CPU 112 temporarily suspends the series of processes shown in the section (b) of FIG. 6.

As shown in the section (a) of FIG. 6, the CPU 72 executes the processes of S56 and S58. When completing the process of S58 or when making a negative determination in the process of S52, the CPU 72 temporarily suspends the series of processes shown in the section (a) of FIG. 6.

The operation and advantage of the second embodiment will now be described.

(4) In the second embodiment, the travel histories of the vehicles VC1 and VC2 are associated with the previously-learned relationship defining data DRt. Here, when the relationship defining data DR of the vehicle VC1 is reset, the previously-learned relationship defining data DRt may be provided which is associated with the traveled distance RL close to the traveled distance RL of the vehicle VC1. In this case, the CPU 72 receives not only the relationship defining data DR transmitted by the vehicle VC1 but also the previously-learned relationship defining data DRt that is based on the relationship defining data DR transmitted by the different vehicle VC2. This increases the possibility of the CPU 72 obtaining more suitable previously-learned relationship defining data DRt that corresponds to the travel history when the relationship defining data DR is reset.

### Third Embodiment

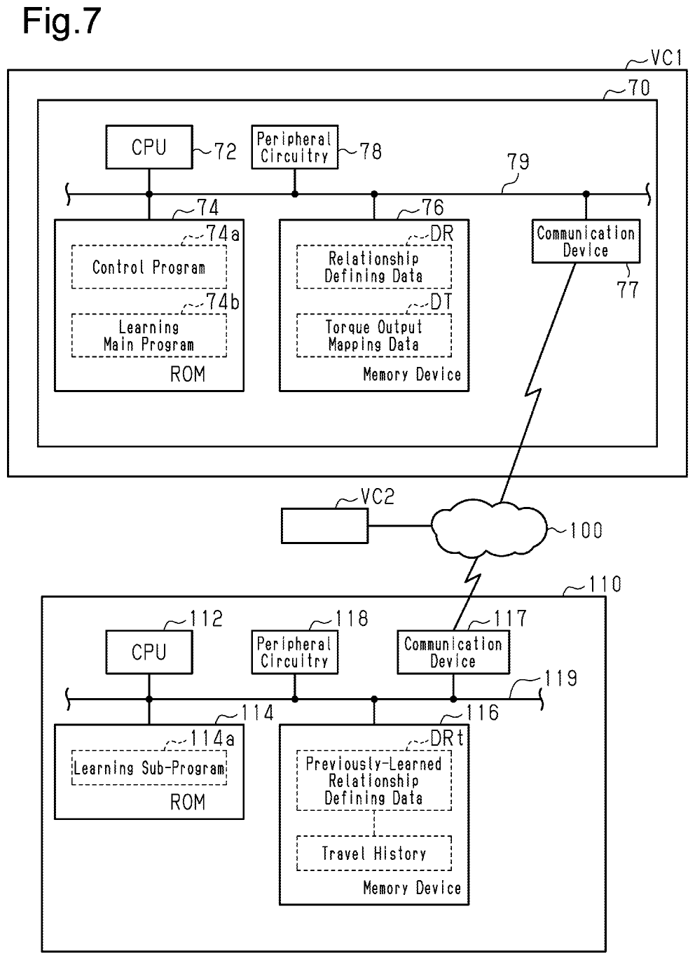

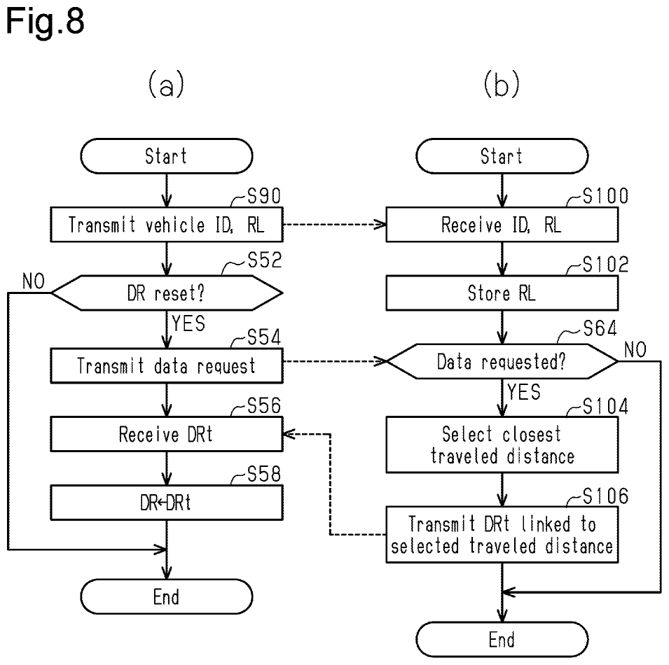

A third embodiment will now be described with reference to FIGS. 7 and 8. Differences from the second embodiment will mainly be discussed.

FIG. 7 shows the vehicle control system according to the third embodiment. In FIG. 7, the same reference numerals are given to the components that are the same as those in FIG. 2 for the illustrative purposes.

As shown in FIG. 7, the memory device 116 in the data analysis center 110 stores multiple of previously-learned relationship defining data DRt associated with travel histories. The multiple of previously-learned relationship defining data DRt have been obtained through, for example, experiments. In the present embodiment, multiple of previously-learned relationship defining data DRt are stored for the traveled distances RL, respectively. Specifically, in the present embodiment, the previously-learned relationship defining data DRt is set for every 5000 km of the traveled distance RL, namely, 5000 km, 10000 km, 15000 km, . . . .

FIG. 8 shows a procedure for dealing with the resetting of the relationship defining data DR in the present embodiment. The processes shown in a section (a) of FIG. 8 are implemented by the CPU 72 repeatedly executing the learning main program 74b stored in the ROM 74 of FIG. 7, for example, at predetermined intervals. The process shown in a section (b) of FIG. 8 is implemented by the CPU 112 executing the learning sub-program 114a stored in the ROM 114. In FIG. 8, the same step numbers are given to the processes that correspond to those in FIG. 6. The process shown in FIG. 8 will now be described with reference to the temporal sequence.

In the series of processes shown in the section (a) of FIG. 8, the CPU 72 first operates the communication device 77 to transmit the identification information ID and the traveled distance RL of the vehicle VC1 (S90).

As shown in the section (b) of FIG. 8, the CPU 112 receives the identification information ID and the traveled distance RL (S100). Then, the CPU 112 uses the value received through the process of S100 to update the traveled distance RL that is associated with the identification information ID stored in the memory device 116 (S102).

As shown in the section (a) of FIG. 8, when the CPU 72 executes the process of S52 and makes an affirmative determination, the CPU 72 executes the process of S54 to transmit a request signal requesting for the previously-learned relationship defining data DRt that is suitable as the relationship defining data DR used for the process of S12 (S54).

As shown in the section (b) of FIG. 6, the CPU 112 executes the process of S64. When determining that the previously-learned relationship defining data DRt has been requested (S64: YES), the CPU 112 selects, from the traveled distances of the previously-learned relationship defining data DRt stored in the memory device 116, the data that indicates the traveled distance closest to the traveled distance RL of the vehicle VC1 that transmitted the request signal (S104).

Next, the CPU 112 operates the communication device 117 to transmit, to the vehicle VC1, the previously-learned relationship defining data DRt that is linked to the traveled distance selected in S104. When completing the process of S106 or making a negative determination in the process of S64, the CPU 112 temporarily suspends the series of processes shown in the section (b) of FIG. 8.

As shown in the section (a) of FIG. 8, the CPU 72 executes the processes of S56 and S58. When completing the process of S58 or when making a negative determination in the process of S52, the CPU 72 temporarily suspends the series of processes shown in the section (a) of FIG. 8.

The operation and advantage of the third embodiment will now be described.

(5) In the third embodiment, when the relationship defining data DR of the vehicle VC1 is reset, the CPU 72 refers to the traveled distance RL of the vehicle VC1 to receive the previously-learned relationship defining data DRt that has been stored in advance. This allows the CPU 72 to employ, as the relationship defining data DR, the previously-learned relationship defining data DRt closest to the traveled distance RL of the vehicle VC1.

Correspondence

The correspondence between the items in the above exemplary embodiments and the items described in the above SUMMARY is as follows. Below, the correspondence is shown for each of the numbers in the examples described in the above SUMMARY.

[1] The in-vehicle controller corresponds to the controller 70. The internal memory device corresponds to the memory device 76. The internal execution device corresponds to the CPU 72 and ROM 74.

The obtaining process corresponds to the processes of S10 and S16. The update process corresponds to the processes from S38 to S44. The operation process corresponds to the process of S14.

The detecting process corresponds to the process of S52. The transmitting process corresponds to the process of S54.

The receiving process corresponds to the process of S56. The switching process corresponds to the process of S58.

The electronic device corresponds to the operated unit of the internal combustion engine. The learning data corresponds to the relationship defining data.

The previously-learned learning data corresponds to the previously-learned relationship defining data.

[2] The out-of-vehicle controller corresponds to the data analysis center 110. The external memory device corresponds to the memory device 116. The external execution device corresponds to the CPU 112 and ROM 114.

The update process corresponds to the processes from S38 to S44. The operation process corresponds to the process of S14.

The detecting process corresponds to the process of S52.

The first transmitting process corresponds to the process of S54. The first receiving process corresponds to the process of S64.

The second transmitting process corresponds to the process of S66. The second receiving process corresponds to the process of S56.

The switching process corresponds to the process of S58.

[3] The periodical transmitting process corresponds to the process of S50. The saving process corresponds to the process of S62.

[4] The travel history transmitting process corresponds to the process of S70. The travel history receiving process corresponds to the process of S80. The travel history saving process corresponds to the process of S82.

The travel history corresponds to the traveled distance RL and position data Pgps.

[5] The travel history corresponds to the traveled distance RL.

[6] The relationship defining data corresponds to the relationship defining data DR. The update map corresponds to the map defined by the command that executes the processes from S38 to S44 in the learning main program 74b.

### Other Embodiments

The present embodiment may be modified as follows. The above-described embodiments and the following modifications can be combined as long as the combined modifications remain technically consistent with each other.

Detecting Process

In the above-described embodiment, when the process of S12 cannot be executed in a suitable manner, the resetting of the relationship defining data DR is detected. However, the detecting process does not have to be executed in such a manner. For example, the controller 70 activates when supplied with power from a battery. Even if the internal combustion engine 10 is not running, the memory device 76 maintains the memory of the relationship defining data DR when the battery of the vehicle VC1 continues to supply power. In this case, for example, a sensor may be used to detect whether power is supplied from the battery to the memory device 76. As long as a state in which the power is supplied from the battery to the memory device 76 can be detected, it can be detected that the relationship defining data DR stored by the memory device 76 is lost when the supply of power from the battery to the memory device 76 is stopped.

Further, when battery-removal memory clearance is performed in a repair garage or the like, the data analysis center 110 may be notified via the network 100 that the relationship defining data DR is lost. Even in this case, the data analysis center 110 can transmit the previously-learned relationship defining data DRt to the controller 70 by executing processes that are similar to those of S60, S62, S66 of the section (b) in FIG. 5.

The detecting process does not have to be executed by one of the controller 70 and the data analysis center 110. For example, when the vehicle control system includes a mobile terminal as described in the Regarding Vehicle Control System below, the mobile terminal may execute the process of detecting that the relationship defining data DR is lost. When the vehicle control system includes the controller 70, the mobile terminal, and the data analysis center 110, the mobile terminal simply needs to transmit, to the data analysis center 110, a signal requesting for the previously-learned relationship defining data DRt after executing the process of detecting that the relationship defining data DR is lost.

Additionally, the process of detecting that the relationship defining data DR is lost is not limited to a process in which the controller 70 directly detects a signal issued by a repair garage or the like. When a signal indicating that the relationship defining data DR is lost due to the occurrence of an anomaly is transmitted to the mobile terminal and is further transmitted from the mobile terminal to the controller 70, the process in which the controller 70 receives the signal from the mobile terminal may be set as the detecting process.

Regarding Action Variable

In the above-described embodiments, the throttle command value TA* is used as an example of the variable related to the opening degree of a throttle valve, which is an action variable. However, the present disclosure is not limited to this. For example, the responsivity of the throttle command value TA* to the accelerator operation amount PA may be expressed by dead time and a secondary delay filter, and three variables, which are the dead time and two variables defining the secondary delay filter, may be used as variables related to the opening degree of the throttle valve. In this case, the state variable is preferably the amount of change per unit time of the accelerator operation amount PA instead of the time-series data of the accelerator operation amount PA.

In the above-described embodiments, the retardation amount aop is used as the variable related to the ignition timing, which is an action variable. However, the present disclosure is not limited to this. For example, the ignition timing, which is corrected by a KCS, may be used as the action variable.

In the above-described embodiments, the variable related to the opening degree of the throttle valve (TA*) and the variable related to the ignition timing (aop) are used as examples of action variables. However, the present disclosure is not limited to this. For example, the variable related to the opening degree of the throttle valve and the variable related to the ignition timing may be replaced by the fuel injection amount. With regard to these three variables, only the variable related to the opening degree of the throttle valve or the fuel injection amount may be used as the action variable. Alternatively, only the variable related to the ignition timing and the fuel injection amount may be used as the action variables. Only one of the three variables may be used as the action variable.

As described in the Regarding Internal Combustion Engine section below, in the case of a compression ignition internal combustion engine, a variable related to an injection amount simply needs to be used as an action variable in place of the variable related to the opening degree of the throttle valve, and a variable related to the injection timing may be used as an action variable in place of the variable related to the ignition timing. In addition to the variable related to the injection timing, it is preferable to use a variable related to the number of times of injection within a single combustion cycle and a variable related to the time interval between the ending point in time of one fuel injection and the starting point in time of the subsequent fuel injection for a single cylinder within a single combustion cycle.

For example, in a case in which the transmission 50 is a multi-speed transmission, the action variable may be the value of the current supplied to the solenoid valve that adjusts the engagement of the clutch using hydraulic pressure.

For example, as described the Regarding Vehicle section below, when a hybrid vehicle, an electric vehicle, or a fuel cell vehicle is used as the vehicle, the action variable may be the torque or the output of the rotating electric machine. Further, when the present disclosure is employed in a vehicle equipped with an air conditioner that includes a compressor, and the compressor is driven by the rotational force of the engine crankshaft, the action variable may include the load torque of the compressor. When the present disclosure is employed in a vehicle equipped with a motor-driven air conditioner, the action variables may include the power consumption of the air conditioner.

Regarding State

In the above-described embodiments, the time-series data of the accelerator operation amount PA includes six values that are sampled at equal intervals. However, the present disclosure is not limited to this. The time-series data of the accelerator operation amount PA may be any data that includes two or more values sampled at different sampling points in time. It is preferable to use data that includes three or more sampled values or data of which the sampling interval is constant.

The state variable related to the accelerator operation amount is not limited to the time-series data of the accelerator operation amount PA. For example, as described in the Regarding Action Variable section above, the amount of change per unit time of the accelerator operation amount PA may be used.

For example, when the current value of the solenoid valve is used as the action variable as described in the Regarding Action Variable section above, the state simply needs to include the rotation speed of the input shaft 52 of the transmission, the rotation speed of the output shaft 54, and the hydraulic pressure regulated by the solenoid valve. Also, when the torque or the output of the rotating electric machine is used as the action variable as described in the Regarding Action Variable section above, the state simply needs to include the state of charge and the temperature of the battery. Further, when the action includes the load torque of the compressor or the power consumption of the air conditioner, the state simply needs to include the temperature in the passenger compartment.

Regarding Reduction of Dimensions of Table-Type Data

The method of reducing the dimensions of table-type data is not limited to the one in the above-described embodiments. The accelerator operation amount PA rarely reaches the maximum value. Accordingly, the action value function Q does not necessarily need to be defined for the state in which the accelerator operation amount PA is greater than or equal to the specified amount, it is possible to adapt the throttle command value TA* and the like independently when the accelerator operation amount PA is greater than or equal to the specified value. The dimensions may be reduced by removing, from possible values of the action, values at which the throttle command value TA* is greater than or equal to the specified value.

Regarding Learning Data

In the above-described embodiments, the learning data is the relationship defining data DR updated through reinforcement learning. Instead, for example, the learning data may be a learning value of the ignition timing updated by learning the ignition timing of the internal combustion engine.

Regarding Learning

As long as a learning value is updated with the traveling of the vehicle VC1, learning may be performed in any manner. For example, the ignition timing of the ignition timing may be learned as described above. Further, updating through learning may be performed in any manner, for example, through feedback control.

Regarding Relationship Defining Data

In the above-described embodiments, the action value function Q is a table-type function. However, the present disclosure is not limited to this. For example, a function approximator may be used.

For example, instead of using the action value function Q, the policy π may be expressed by a function approximator that uses the state s and the action a as independent variables, and the parameters defined by the function approximator may be updated in correspondence with the reward r.

Regarding Operation Process

For example, when using a function approximator as the action value function Q as described in the Regarding Relationship Defining Data section above, all the actions of the groups of discrete values related to actions that are independent variables of the table-type function of the above-described embodiments are input to the action value function Q together with the state s. The action a that maximizes the action value function Q simply needs to be selected.

For example, when the policy 7E is a function approximator that uses the state s and the action a as independent variables, and uses the probability that the action a will be taken as a dependent variable as in the Regarding Relationship Defining Data section above, the action a simply needs to be selected based on the probability indicated by the policy 7C.

Regarding Update Map

The ε-soft on-policy Monte Carlo method is executed in the process from S38 to S44. However, the present disclosure is not limited to this. For example, an off-policy Monte Carlo method may be used. Also, methods other than Monte Carlo methods may be used. For example, an off-policy TD method may be used. An on-policy TD method such as a SARSA method may be used. Alternatively, an eligibility trace method may be used as an on-policy learning.

For example, when the policy π is expressed using a function approximator, and the function approximator is directly updated based on the reward r, the update map is preferably constructed using, for example, a policy gradient method.

The present disclosure is not limited to the configuration in which only one of the action value function Q and the policy π is directly updated using the reward r. For example, the action value function Q and the policy π may be separately updated as in an actor critic method. In an actor critic method, the action value function Q and the policy π do not necessarily need to be updated. For example, in place of the action value function Q, a value function V may be updated.

The letter ε defining the policy π is not limited to a fixed value and may be changed in accordance with the rule defined in advance according to the degree of learning progress.

Regarding Reward Calculating Process

In the process of FIG. 3, the reward is provided depending on whether the logical disjunction of the conditions (i) and the condition (ii) is true. However, the present disclosure is not limited to this. For example, a process that provides a reward depending on whether the condition (i) is met and a process that provides a reward depending on whether the condition (ii) is met may be executed. Further, for example, only one of these two processes may be executed.

For example, instead of providing the same reward without exception when the condition (i) is met, a process may be executed in which a greater reward is provided when the absolute value of the difference between the torque Trq and the torque command value Trq* is small than when the absolute value is great. Also, instead of providing the same reward without exception when the condition (i) is not met, a process may be executed in which a smaller reward is provided when the absolute value of the difference between the torque Trq and the torque command value Trq* is great than when the absolute value is small.

For example, instead of providing the same reward without exception when the condition (ii) is met, a process may be executed in which the reward is varied in accordance with the acceleration Gx. Also, instead of providing the same reward without exception when the condition (ii) is not met, a process may be executed in which the reward is varied in accordance with the acceleration Gx.

In the above-described embodiments, the reward r is provided according to whether the drivability-related standard is met. Instead, the reward may be set according to whether the standard of, for example, noise or vibration intensity is met. Alternatively, the reward may be set according to whether one or more of four drivability-related standards is met which include whether the standard of the acceleration is met, whether the standard of the followability of the torque Trq is met, whether the standard of noise is met, and whether the standard of vibration intensity is met.

The reward calculating process is not limited to a process of providing the reward r according to whether the drivability-related standard is met. Instead, for example, the reward calculating process may be a process that provides a greater reward when the fuel consumption rate meets a standard is met than the fuel consumption rate does meet a standard. Alternatively, for example, the reward calculating process may be a process that provides a greater reward when the exhaust characteristic meets a standard than when the exhaust characteristic does not meet the standard. The reward calculating process may include two or three of the following processes: the process that provides a greater reward when the standard related to drivability is met than when the standard is not met; the process that provides a greater reward when the fuel consumption rate meets the standard than when the energy use efficiency does not meet the standard; and the process that provides a greater reward when the exhaust characteristic meets the standard than when the exhaust characteristic does not meet the standard.

For example, when the current value of the solenoid valve of the transmission 50 is used as the action variable as described in the Regarding Action Variable section above, the reward calculating process simply needs to include one of the three processes (a) to (c).

(a) A process that provides a greater reward when time required for the transmission to change the gear ratio is within a predetermined time than when the required time is exceeds the predetermined time.

(b) A process that provides a greater reward when the absolute value of the rate of change of the rotation speed of the transmission input shaft 52 is less than or equal to an input-side predetermined value than when the absolute value exceeds the input-side predetermined value.

(c) A process that provides a greater reward when the absolute value of the rate of change of the rotation speed of the transmission output shaft 54 is less than or equal to an output-side predetermined value than when the absolute value exceeds the output-side predetermined value.

Also, when the torque or the output of the rotating electric machine is used as the action variable as described in the Regarding Action Variable section above, the reward calculating process may include the following processes: a process that provides a greater reward when the state of charge of the battery is within a predetermined range than when the state of charge is out of the predetermined range; and a process that provides a greater reward when the temperature of the battery is within a predetermined range than when the temperature is out of the predetermined range. Further, when the action variable includes the load torque of the compressor or the power consumption of the air conditioner as described in the Regarding Action Variable section above, the reward calculating process may include a process that provides a greater reward when the temperature in the passenger compartment is within a predetermined range than when the temperature is out of the predetermined range.

Regarding Vehicle Control System

The vehicle control system does not necessarily include the controller 70 and the data analysis center 110. For example, the vehicle control system may include a portable terminal carried by a user in place of the data analysis center 110, so that the vehicle control system includes the controller 70 and the portable terminal. Also, the vehicle control system may include the controller 70, a portable terminal, and the data analysis center 110. The controller 70 may simply need to receive at least the previously-learned relationship defining data DRt from the outside of the vehicle VC1.

Regarding Communication Device

In the above-described embodiments, the transmission in S54 and the reception in S56 in the section (a) of FIG. 5 are executed by operating the communication device 77. The communication device 77 is not limited to a device installed in the vehicle VC1 and may be, for example, a smartphone carried by the user of the vehicle VC1. In this case, the controller 70 and the smartphone may be electrically connected to each other through near-field communication or wired communication so that the smartphone functions as the communication device 77 to communicate with the outside of the vehicle.

Regarding Out-of-Vehicle Controller

In the above-described embodiments, the data analysis center 110 is illustrated as an example of the out-of-vehicle controller but not limited to this. To function as the out-of-vehicle controller for the vehicle VC1, the out-of-vehicle controller for the controller 70 simply needs to be arranged outside of the vehicle VC1. For example, the out-of-vehicle controller for the vehicle VC1 may be a controller installed in a vehicle that differs from the vehicle VC1. In this case, the vehicle control system may include, for example, the controller 70 for the vehicle VC1 and the controller for the vehicle that differs from the vehicle VC1. Even in this case, the controller for the different vehicle functions as the out-of-vehicle controller for the vehicle VC1.

Regarding Execution Device

The execution device is not limited to the device that includes the CPU 72 (112) and the ROM 74 (114) and executes software processing. For example, at least part of the processes executed by the software in the above-described embodiments may be executed by hardware circuits dedicated to executing these processes (such as ASIC). That is, the execution device may be modified as long as it has any one of the following configurations (a) to (c). (a) A configuration including a processor that executes all of the above-described processes according to programs and a program storage device such as a ROM (including a non-transitory computer readable memory medium) that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. Multiple software processing devices each including a processor and a program storage device and a plurality of dedicated hardware circuits may be provided.

Regarding Memory Device

In the above-described embodiments, the memory device storing the relationship defining data DR and the memory device (ROM 74) storing the learning main program 74b and the control program 74a are separate from each other. However, the present disclosure is not limited to this.

Regarding Internal Combustion Engine

The internal combustion engine does not necessarily include, as the fuel injection valve, a port injection valve that injects fuel to the intake passage 12. Instead, the internal combustion engine may include, as the fuel injection valve, a direct injection valve that injects fuel into the combustion chamber 24. Further, the internal combustion engine may include a port injection valve and a direct injection valve.

The internal combustion engine is not limited to a spark-ignition engine, but may be a compression ignition engine that uses, for example, light oil or the like.

Regarding Vehicle

The vehicle is not limited to a vehicle that includes only an internal combustion engine as a propelling force generator, but may be a hybrid vehicle includes an internal combustion engine and a rotating electric machine. Further, the vehicle may be an electric vehicle or a fuel cell vehicle that includes a rotating electric machine as the propelling force generator, but does not include an internal combustion engine.

Regarding Travel History

In the second embodiment, the travel history is not limited to the traveled distance RL and position data Pgps. Instead, for example, multiple of position data Pgps during traveling that serve as travel histories may be used to calculate the traveled distance and traveled position. The same applies to the third embodiment.

Regarding Transmission and Reception of Travel History

In the second embodiment, the data indicating a travel history is transmitted from the vehicle VC1 at the same time as the process of S54 in the section (a) of FIG. 6. In this case, the data indicating a travel history simply needs to be received by the CPU 112 at the same time as the process of S64 in the section (b) of FIG. 6, and the process of S82 simply needs to be executed after S64.

Further, the vehicle VC1 may transmit the relationship defining data DR of the vehicle VC1 at the same time as transmitting the data indicating the travel history in S70 of the section (a) in FIG. 6. In this case, the data analysis center 110 receives the relationship defining data DR of the vehicle VC1 in S80 of the section (b) in FIG. 6 and stores the relationship defining data DR of the vehicle VC1 in S82. Additionally, the data analysis center 110 may omit the process of S86 and select the data stored in the memory device 116 in the process of S84.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle controller, comprising an in-vehicle controller that includes an internal memory device and an internal execution device, wherein
the internal memory device is configured to store learning data used to control an electronic device installed in a vehicle, and
the internal execution device is configured to execute:
an obtaining process that obtains a detection value of a sensor that detects a state of the vehicle;
an update process that updates the learning data through learning with traveling of the vehicle and causes the internal memory device to store the updated learning data;
an operation process that operates the electronic device based on the detection value obtained by the obtaining process and based on a value of a variable that is related to an operation of the electronic device in the vehicle and is defined by the learning data;
a detecting process that detects that the learning data stored in the internal memory device has been reset due to occurrence of an anomaly in the vehicle;
a transmitting process that transmits, to an outside of the vehicle, a request signal that requests for previously-learned learning data, where learning is performed from an initial state of the learning data, when the detecting process detects that the learning data has been reset;
a receiving process that receives, from the outside of the vehicle, the previously-learned learning data corresponding to the request signal; and
a switching process that causes the internal memory device to store the previously-learned learning data received by the receiving process instead of the reset learning data.

2. A vehicle control system, comprising an in-vehicle controller installed in a vehicle and an out-of-vehicle controller arranged outside of the vehicle, wherein
the in-vehicle controller includes an internal memory device and an internal execution device,
the out-of-vehicle controller includes an external memory device and an external execution device,
the internal memory device is configured to store learning data used to control an electronic device installed in the vehicle, and
the external memory device is configured to store previously-learned learning data, where learning is performed from an initial state of the learning data,
the internal execution device is configured to execute:
an obtaining process that obtains a detection value of a sensor that detects a state of the vehicle;
an update process that updates the learning data through learning with traveling of the vehicle and causes the internal memory device to store the updated learning data;
an operation process that operates the electronic device based on the detection value obtained by the obtaining process and based on a value of a variable that is related to an operation of the electronic device in the vehicle and is defined by the learning data;
a detecting process that detects that the learning data stored in the internal memory device has been reset due to occurrence of an anomaly in the vehicle; and
a first transmitting process that transmits, to the out-of-vehicle controller, a request signal that requests for the previously-learned learning data when the detecting process detects that the learning data has been reset,
the external execution device is configured to execute:
a first receiving process that receives, from the internal execution device, the request signal transmitted by the first transmitting process; and
a second transmitting process that transmits, to the in-vehicle controller, in response to the request signal received by the first receiving process, a signal indicating the previously-learned learning data stored in the external memory device, and
the internal execution device is configured to execute:
a second receiving process that receives the signal that indicates the previously-learned learning data, the signal having been transmitted by the second transmitting process; and
a switching process that causes the internal memory device to store the previously-learned learning data received by the second receiving process instead of the reset learning data.

3. The vehicle control system according to claim 2, wherein
the internal execution device is configured to execute a periodical transmitting process that transmits, to the out-of-vehicle controller for a predetermined period, a signal indicating the learning data updated by the update process,
the external execution device is configured to execute:
a periodical receiving process that receives the signal that indicates the learning data, the signal having been transmitted by the periodical transmitting process; and
a saving process that saves, as the previously-learned learning data in the external memory device, the learning data received by the periodical receiving process, and
the previously-learned learning data transmitted by the external execution device in the second transmitting process is latest data saved by the saving process.

4. The vehicle control system according to claim 2, wherein
the internal execution device is configured to execute a travel history transmitting process that transmits, to the out-of-vehicle controller, a signal indicating a travel history of the vehicle including the internal execution device,
the external execution device is configured to execute:
a travel history receiving process that receives signals indicating travel histories, the signals having been transmitted by vehicles; and
a travel history saving process that saves, in the external memory device for each of the vehicles, the travel histories received by the travel history receiving process, and
the previously-learned learning data transmitted by the second transmitting process is associated with a travel history closest to the travel history of the vehicle that transmitted the request signal, of the travel histories of the vehicles saved by the travel history saving process.

5. The vehicle control system according to claim 2, wherein
traveling histories and multiple of the previously-learned learning data respectively corresponding to the travel histories are set in advance for the external memory device in association with each other,
the internal execution device is configured to transmit, in the first transmitting process, a signal indicating a travel history of the vehicle when the learning data of the vehicle is reset,
the external execution device is configured to receive the travel history in the first receiving process, and
the previously-learned learning data transmitted by the external execution device in the second transmitting process is associated with a travel history closest to the travel history of the vehicle that transmitted the request signal, of the travel histories stored in the external memory device.

6. The vehicle control system according to claim 2, wherein
the learning data is relationship defining data that defines a relationship between the state of the vehicle and an action variable related to the operation of the electronic device in the vehicle,
the internal execution device is configured to execute a reward calculating process that provides, based on the detection value obtained by the obtaining process, a greater reward when a characteristic of the vehicle meets a standard than when the characteristic of the vehicle does not meet the standard,
the update process updates the relationship defining data by inputting, to a predetermined update map, the state of the vehicle that is based on the detection value obtained by the obtaining process, the value of the action variable used to operate the electronic device, and the reward corresponding to the operation of the electronic device, and
the update map outputs the updated relationship defining data so as to increase an expected return for the reward in a case where the electronic device is operated in accordance with the relationship defining data.

7. A vehicle control method, comprising:
storing, by an internal memory device, learning data used to control an electronic device installed in a vehicle;
obtaining, by an internal execution device, a detection value of a sensor that detects a state of the vehicle;
updating, by the internal execution device, the learning data through learning with traveling of the vehicle;
causing, by the internal execution device, the internal memory device to store the updated learning data;
operating, by the internal execution device, the electronic device based on the obtained detection value and based on a value of a variable that is related to an operation of the electronic device in the vehicle and is defined by the learning data;
detecting, by the internal execution device, that the learning data stored in the internal memory device has been reset due to occurrence of an anomaly in the vehicle;
transmitting, by the internal execution device, to an outside of the vehicle, a request signal that requests for previously-learned learning data, where learning is performed from an initial state of the learning data, when detecting that the learning data has been reset;
receiving, by the internal execution device, from the outside of the vehicle, the previously-learned learning data corresponding to the request signal; and
causing, by the internal execution device, the internal memory device to store the received previously-learned learning data instead of the reset learning data.

8. A vehicle control system control method executed by an in-vehicle controller installed in a vehicle and an out-of-vehicle controller arranged outside of the vehicle, the in-vehicle controller including an internal memory device and an internal execution device, the out-of-vehicle controller including an external memory device and an external execution device, the vehicle control system control method comprising:
storing, by the internal memory device, learning data used to control an electronic device installed in the vehicle;
storing, by the external memory device, previously-learned learning data, where learning is performed from an initial state of the learning data;
obtaining, by the internal execution device, a detection value of a sensor that detects a state of the vehicle;
updating, by the internal execution device, the learning data through learning with traveling of the vehicle
causing, by the internal execution device, the internal memory device to store the updated learning data;
operating, by the internal execution device, the electronic device based on the obtained detection value and based on a value of a variable that is related to an operation of the electronic device in the vehicle and is defined by the learning data;
detecting, by the internal execution device, that the learning data stored in the internal memory device has been reset due to occurrence of an anomaly in the vehicle;
transmitting, by the internal execution device, to the out-of-vehicle controller, a request signal that requests for the previously-learned learning data when detecting that the learning data has been reset;
receiving, by the external execution device, from the internal execution device, the transmitted request signal;
transmitting, by the external execution device, to the in-vehicle controller, in response to the received request signal, a signal indicating the previously-learned learning data stored in the external memory device;
receiving, by the internal execution device, the transmitted signal that indicates the previously-learned learning data; and
causing, by the internal execution device, the internal memory device to store the received previously-learned learning data instead of the reset learning data.
